(19) United States
(12) Patent Application Publication
(10) Pub. No.: US 2017/0000295 A1
(43) Pub. Date: Jan. 5, 2017

(54) Container-Dispenser Apparatus

(71) Applicants: Paul J Hanna, Wexford, PA (US); Ronald A. Esposito, JR., Mars, PA (US)

(72) Inventors: Paul J Hanna, Wexford, PA (US); Ronald A. Esposito, JR., Mars, PA (US)

(73) Assignee: AIP Creations, LLC, Mars, PA (US)

(21) Appl. No.: 14/791,342

(22) Filed: Jul. 3, 2015

(51) Int. Cl. A47J 47/01; B65D 25/02; B65B 1/06; B65D 51/28; B65D 83/06; A47J 47/04; B65D 47/06

(52) U.S. Cl. CPC A47J 47/01; A47J 47/04; B65D 25/02; B65D 47/06; B65D 51/28; B65D 83/06; B65B 1/06

(57) ABSTRACT

A container-dispenser (100) provided with one or more chambers (30a) formed by fixed or removable walls (40) mating with notches and grooves formed on surfaces inside a container body (30c), the chambers sealed by a rotatable lid (10) with a port (20) or spout (10d) on a top side, and a center post seal (62a) with an array of spoke-like lid channels (62b) radiating outwards to a perimeter channel (64) on an underside of the lid forming a series of adjacent hollow spaces (62). A funnel (50) having a neck (50b) approximating a shape of the opening of the container body (30) created by a center post (30c) and an interior container wall (30h) is also provided. The spout or port allows access to a quantity of stored powder or pieced foods stored in the chambers, and the funnel allows each chamber to be easily and securely filled.

### CROSS REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE OF MATERIAL SUBMITTED ON A COMPACT DISC OR AS A TEXT FILE VIA THE EFS WEB SYSTEM

Not applicable.

### STATEMENT REGARDING PRIOR DISCLOSURES BY THE INVENTOR OR A JOINT INVENTOR

Not applicable.

### BACKGROUND OF THE INVENTION

Field of the Invention

The invention pertains to the field of containers and dispensers for quantities of food. More particularly, the invention pertains to the field of combined container-dispenser apparatuses adapted to store, organize, dispense, and transport quantities of food, particularly powdered foods.

Background Art

Travel has always created inconvenience, but in particular, those who travel frequently are constantly subject to difficult transportation options with respect to supplements or pre-measured foods. Vitamins and other small pills are easily organized, stored, and transported in pill containers, but no easy solution exists for powder supplements, such as whey protein drink mixes, powdered vitamin drinks, baby formula, ground coffee, etc. When a single powder supplement is used, a traveler will place a quantity of powder into a plastic bag or container, and then pack a measuring scoop or spoon, a drink container into which the powder is dispensed, and a stirring tool such as a whisk for mixing the powder. The main problem with this solution is its inconvenience, and premeasuring and preparing multiple small bags or loose containers so as to eliminate the measuring utensil is tedious and bulky.

When multiple powders are used, organizing, packing, and mixing the powders becomes even more difficult: separate containers and separate scoops must be packed, labelled, and organized as there is no universal or standard amount of powder for any given supplement—so one brand of supplement may have its own scoop and a different brand may use a completely different scoop, and the powder containers and measuring scoops must be identified and kept organized. Further, whether a traveler takes a single powder or multiple powders, the powders must be mixed with a source of liquid, and for many travelers, bottled water is the only reliable and readily available clean source of potable water. The water bottle lid also allows the traveler to mix the powder by shaking the bottle's contents, eliminating the need for a mixing tool. However, since powders are generally messy to measure, dispense, and mix even when using a cup, when the bottle of water is the only liquid container that can be used for mixing the powder, unless the traveler remembered to bring a funnel, measuring and then dispensing the powder cleanly and completely into the bottle of water is a hassle. In particular, the combination of a tall, thin water bottle and a wobbly funnel inserted into, but not securely attached to the bottle, creates spillage opportunities.

Even if the traveler is very organized and can remember all the measuring scoops, amounts, etc., using plastic bags or disposable containers are not always a good option for storing and transporting multiple powders, since bags can rip and common plastic containers stored in a suitcase are subject to abuse during travel and may crack or spill powder. Bags or containers can also get lost, so the traveler must scrupulously count and organize the multiple bags or containers to ensure a dose is not missing.

What is needed is a container that can safely and conveniently transport premeasured quantities of powder or other foods and keep quantities of stored powders or other foods separate from one another.

What is also needed is an easy to use dispenser that allows convenient dispensing of powder from the container into a conventional water bottle, and cleanly dispenses other foods.

### BRIEF SUMMARY OF THE INVENTION

Accordingly, in a first aspect of the invention, an apparatus for storing and dispensing a quantity of food is comprised of a container body having an opening at a top end, an opposed base, a continuous, curved interior wall defining an interior space, and a center post affixed to and rising upwards from the base and terminating at the opening. Walls are affixed to both the center post and to the interior wall, forming chambers in the interior space.

In a second aspect of the invention, embodiments for fixed and removable walls are included. In embodiments having removable walls, each wall is further formed as an I-beam having a web sandwiched between a pair of flanges. The center post and interior wall are notched, the notches adapted to receive the flanges. The base of the container body is further formed with a groove adapted to receive a wall bottom.

In a third aspect of the invention, the container body is further comprised of a lid having a top side and an underside, the top side having at least one of a spout or port, and the underside having a center post seal with a spoke-like array of lid channels radiating outwards from the center post seal to a perimeter channel of the underside of the lid. The lid mates with the top end of the container body, in some embodiments via mating threads formed along the lid and the container top end, and in other embodiments by a pressure fit. The lid channels mate with a wall top, sealing each chamber in the container body.

In yet a fourth aspect of the invention, the lid is a bipartite lid having upper lid independently rotatable from a lower lid mateable with the top end of the container body.

In a fifth aspect of the invention, a funnel having a mouth and a neck approximating a shape of the opening of the top end of the container body between the center post and the curved, interior wall of the container body is included, the neck pressure fitting into the opening of the container body so as to allow secure and quick filling of the chambers.

### BRIEF DESCRIPTION OF THE DRAWINGS

The features and advantages of the invention will become apparent from a consideration of the subsequent detailed description presented in connection with accompanying drawings, in which:

FIG. 1A is an exploded view of the improved container-dispenser apparatus, showing a container body housing a plurality of removable walls, a lid covering the container body, and a funnel for use with the container body.

FIG. 1B is a top view of the container body, funnel, and walls from FIG. 1A, showing the funnel and the walls in a storage orientation inside the container body.

FIG. 1C is a perspective view of the funnel in FIG. 1A.

FIG. 1D is a top view of the funnel in FIGS. 1A and 1C.

FIG. 1E is a perspective view of the funnel engaging a top end of the container body and in a chamber filling position, showing the container body partitioned into six chambers by six walls.

FIG. 2A is a first perspective view of the top end of the container body showing a center post and notches formed into the center post and an interior wall of the container body, but without partitioning of the container body into chambers.

FIG. 2B is a second perspective view of the top end of the container body, showing three removable walls engaging notches formed in the center post and in the interior wall of the container body, forming 3 chambers with differing volumes as compared to one another.

FIG. 3 is a perspective view of the improved container-dispenser apparatus, shown with a bipartite lid engaging the top end of the container body, an upper lid independently rotatable from a lower lid engaging the container body.

FIG. 4A is a perspective view of the bipartite lid in FIG. 3, showing an underside of the upper lid having a raised center post seal and a spoke-like array of lid channels radiating outwards from the center post seal and towards a perimeter of the upper lid. The lower lid features threads adapted to mate with corresponding threads on the top end of the container body (as in FIG. 2A)

FIG. 4B is a bottom view of the lid shown in both FIGS. 4A and 8A, the lid shown with both a spout and a port in dispensing position.

FIGS. 5A-B are perspective views of the walls as they would appear affixed to the center post and container interior wall, forming chambers, but shown without the container body wall for ease of viewing, and the underside of the lid. In FIG. 5A, the lid and walls are shown in an exploded view prior to coupling the lid to the container body, and thus to the walls, and in FIG. 5B, the walls are shown engaging the lid channels upon coupling the lid to the container body.

FIGS. 6A-E are views of the removable walls shown in perspective, top, first side, second side, and bottom views, respectively.

FIG. 7A is a perspective view of the container body, with a cutaway portion of the container wall showing grooves formed in a base.

FIG. 7B is a top view of the base shown in the cutaway portion of FIG. 7.

FIGS. 8A-B are a perspective view and a side elevation view, respectively of the improved container-dispenser shown with a lip formed on the container body mateable with a mating groove formed into the lid.

### DRAWINGS LIST OF REFERENCE NUMERALS

The following is a list of reference labels used in the drawings to label components of different embodiments of the invention, and the names of the indicated components.
100 improved container-dispenser apparatus
lid
10a upper lid
10b lower lid
10bb threads on lower lid
10c space or gap
10d spout
10f aperture
10g guide
20 port
20a flip top or port lid
30 container body
30a chamber
30aa interior space of container body
30c center post
30d post notch
30dd wall notch
30f groove
30gg threads on container body
30h interior wall of container body
30i base
30m top end of container body
30k bottom end of container body
30p mating groove (of lid)
30pp lip (of container body)
40 wall
40a wall bottom
40b wall top
42 flange
44 wall body or web
50 funnel
50b neck
50c mouth
62 hollow space
62a center post seal
62b lid channel
64 perimeter channel

### GLOSSARY

Food: any ingestible liquid, powder, and edible materials, and includes dietary supplements.

Dietary Supplements: includes any edible or ingestible form of powder, pills, and foods that comprise multiple pieces, such as candy, granola, cereal, etc.

### DETAILED DESCRIPTION

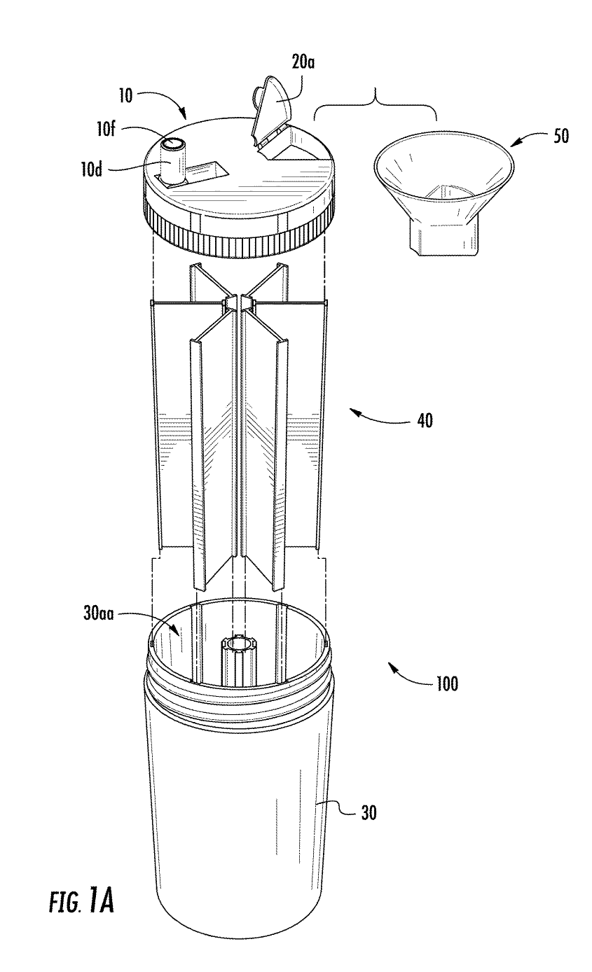

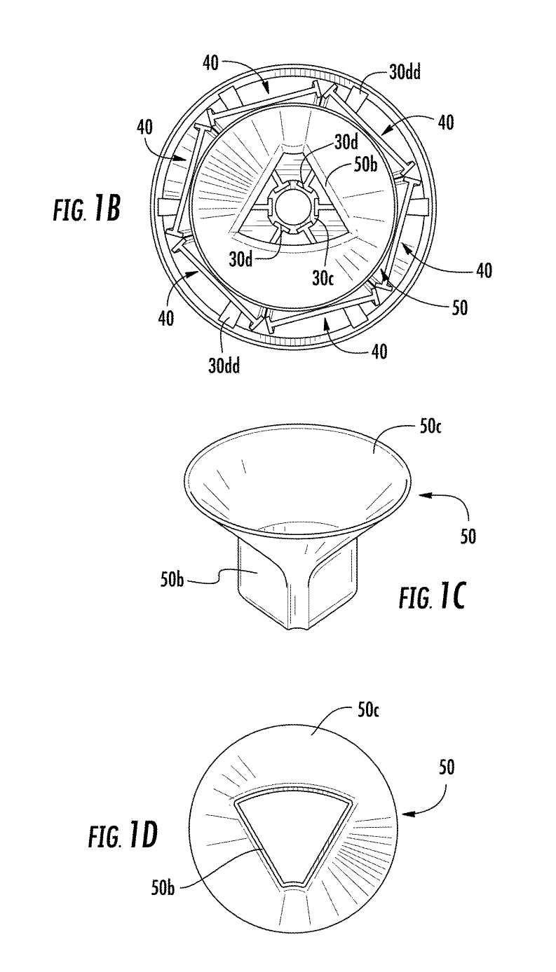

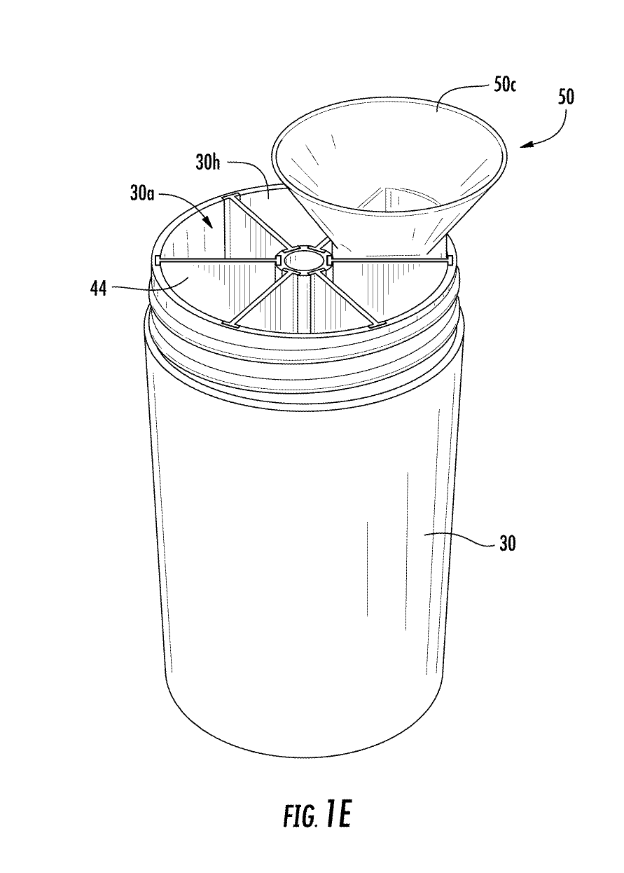

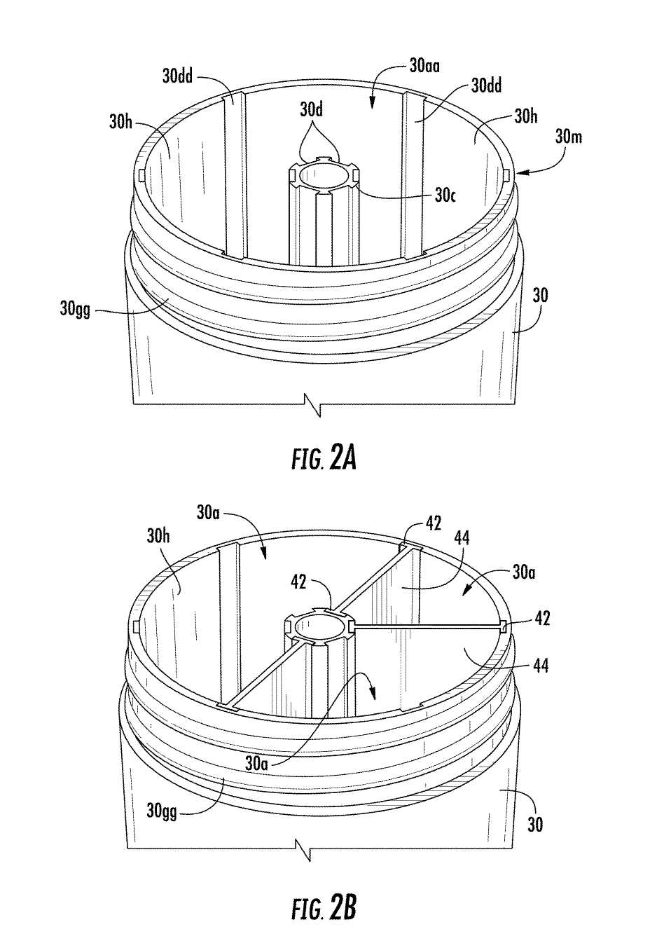

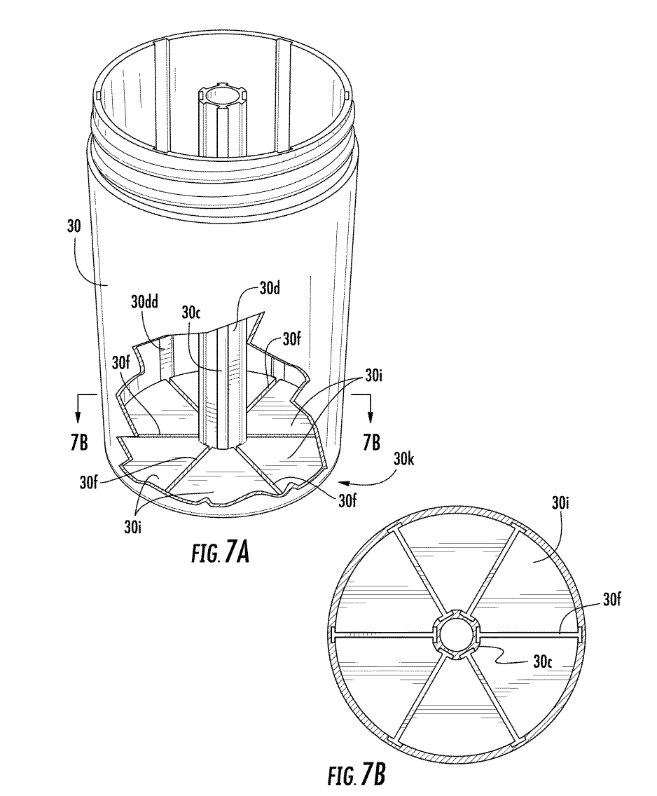

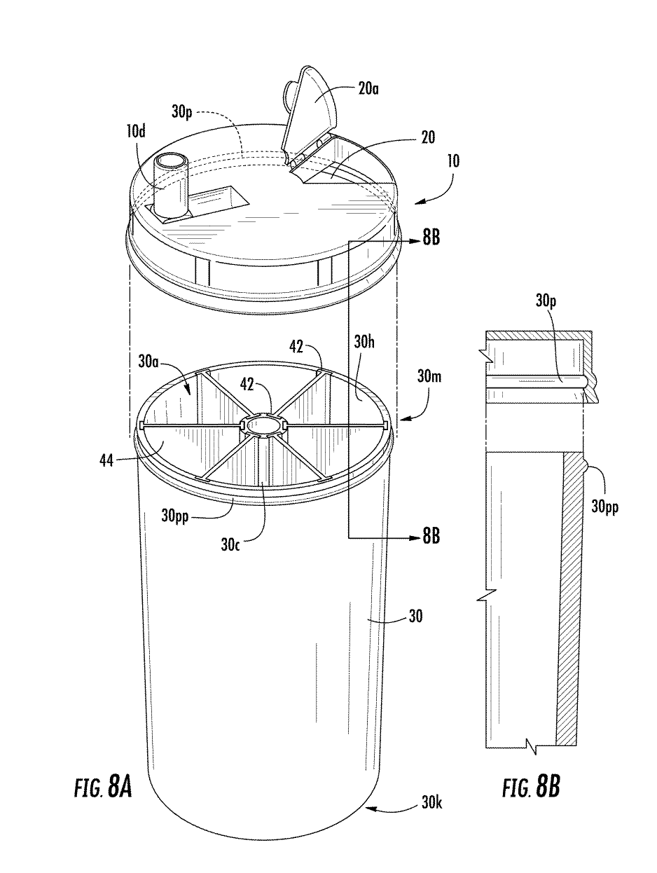

The invention 100 is an improved container-dispenser apparatus described below and in FIGS. 1A-8B.

The invention allows dietary supplements, in powdered form or apportioned or pieced, such as pills, to be easily and safely transported, stored, organized and dispensed. The term “dietary supplements” is meant to include any edible or ingestible form of powder, pills or small foods often comprising multiple pieces, such as nuts, candy, granola, and even ground coffee and dried herbs. The invention protects the dietary supplements during transportation since the container body is designed to withstand moderate impact and physical abuse that potentially occurs during travel conditions.

The inventors note that the invention's primary function is the transportation, storage, organization, separation and dispensing of various powders into the small openings of bottles (i.e. water bottles) where the normal methods of scooping powder from one container to another is either undesirable or not practical.

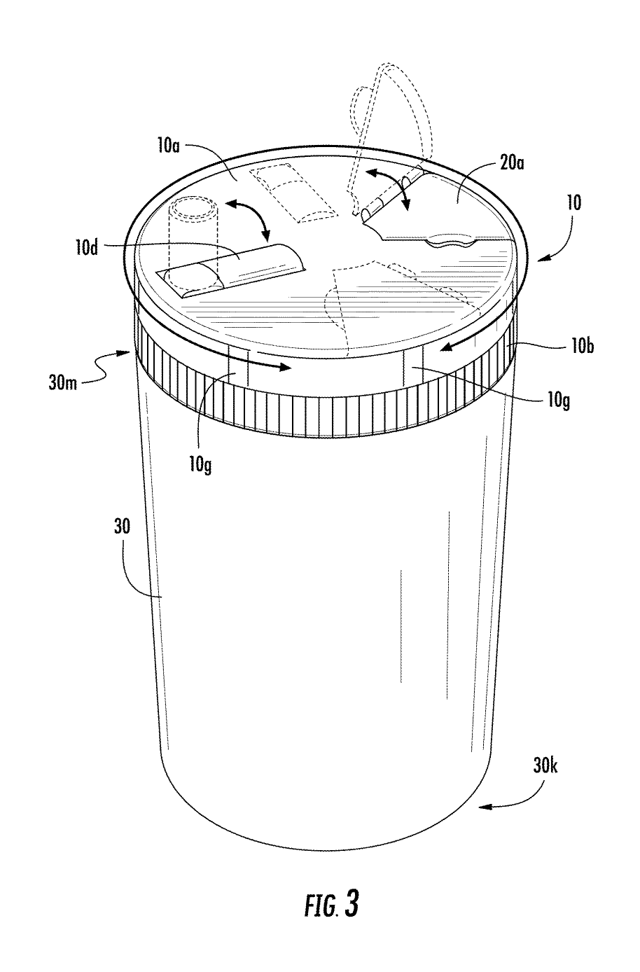

Turning now to the Figures, the invention 100 is comprised of an inverted conical frustum having a container body 30 with a top end 30m and in one embodiment, shown in FIG. 2A, having an array of threads 30gg formed along the top end 30m, and in a second embodiment, shown in FIGS. 8A-B, with a lip 30pp in lieu of threads. The container body 30 tapers from the top end to a bottom end 30k so as to have a larger diameter across the top end as compared to the bottom end. This shape is allows the container body 30 to fit conveniently into a standard vehicle cup holder, as well as allowing an array of hand sizes to comfortably grasp the container body 30. An interior space 30aa of the container body 30 is defined by an interior wall 30h of the container body, an opening at the top of the container body 30 and an opposed base 30i with an affixed center post 30c rising from the base 30i through the interior space 30aa to the top of the container body. In a typical embodiment, the center post 30c is a hollow cylindrical space so as to reduce weight and material.

Turning now to FIGS. 2A-B, and 6A-E, in a typical embodiment having at least one removable wall 40, the interior container wall 30h is further comprised of at least one wall notch 30dd shown as a groove formed into the interior container wall. Opposite the wall notch 30dd and formed along the center post 30c is a post notch 30d formed as a groove in the center post, both wall notches 30dd and post notches 30d sized and shaped to receive the at least one removable wall 40. In FIGS. 6A-E the wall 40 is “I” shaped, with a flange 42 on either end of a web 44. The wall notch 30dd and the post notch 30d each receive the wall flanges 42 of the wall 40. As with the container body 30, each wall 40 is tapered (FIGS. 6C-D), and minus the flanges 42, resembles an inverted truncated rectangular pyramid, corresponding to the tapering container body 30 so when the flanges 42 engage the post notches 30d and wall notches 30dd, the walls 40 fit snugly inside the interior space 30aa of the container body 30. In an illustrative example, in FIGS. 6B-E, a first width W1 is approximately 1⅜ inches wide, a second width W2 is approximately 1 inch wide, a third width W3 is approximately 2/16 inches, wide, and a fourth width W4 is approximately 1/16 inches wide. The widths W1-W5 correspond to the shape of the interior space 30aa, between the center post 30a and the interior wall 30h. The center post 30c is approximately ¾ inch wide. A top diameter of the container body measured at the top end 30m is about 3 7/16 inches, and with the lid affixed to the container body, the top diameter is about 3 11/16 inches. The inventors note that these dimensions are illustrative only, and different wall widths and top diameters will not detrimentally change the function of the invention, so long as the shape of the wall complements the shape of the container body. The base 30i is further formed with a groove 30f to receive a wall bottom 40a of the wall 40. The grooves 30f and notches 30d 30dd prevent contents of one chamber leaking into an adjoining chamber.

Turning to FIGS. 2A-B and 8A, the interior space 30aa is partitioned so as to create a plurality of chambers 30a. In FIG. 2A, the interior space 30aa is not partitioned. In FIG. 2B, three removable walls are shown engaging the notches 30d 30dd, and creating three chambers 30a, all of differing volumes and of differing shapes. FIG. 8A shows six removable walls partitioning the interior space 30aa into six chambers 30a of a same volume and a same shape. These Figures illustrate the customizable character of the chamber 30. Walls 40 can be removed or inserted as desired. Any variation or array from a single interior space 30aa (no walls) to a total of six chambers (six walls) is possible. In yet another embodiment (not shown) the walls are fixed, forming six individual chambers 30a.

The chambers 30a allow for the convenient separation and organization of dietary supplements, and allow a single container-dispenser to separately store and dispense both powdered supplements and apportioned supplements such as pills or other foods that are commonly stored in multiple piece, such as crackers and cereal. It should be noted that the walls 40, post notches 30d, and wall notches 30dd span the entire length of the chamber 30a, from the base 30i to the an uppermost edge of the top end 30m of the container body 30, as shown in FIG. 2B, for instance, to prevent cross contamination across the chambers.

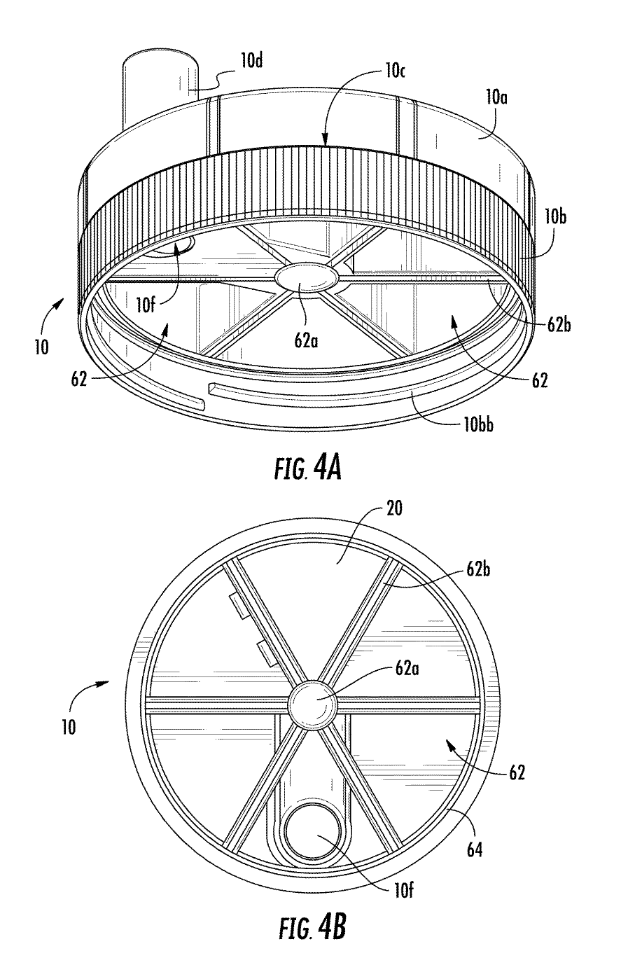

Turning now to FIGS. 3, 4A-B and 8A-B, the invention provides for a lid 10 having a spout 10d and in a typical embodiment, an additional opposed port 20 with a flip top lid 20a. In the embodiment shown in FIGS. 3-4A, the lid 10 is a bipartite lid further comprised of an upper lid 10a into which the spout 10d and the port 20 with the flip top lid 20a is affixed, and a lower lid 10b having mating means, typically formed as an array of threads 10bb along an interior perimeter of the lid mating with an array of threads 30gg formed along the top end 30m of the container body 30. The inventors believe that complementary threaded mating structures are a convenient way in which to secure the lids to the container body, however the threads are just a typical example of mating structures suitable for the invention and are not meant to limit the mating of the lid to the container body to just mating threads. In another embodiment shown in FIGS. 8A-B, the lid and container body are coupled using a snap on lid in which the lid 10 is forced onto the top end 30m of the container body 30 and held in place by engaging a mating groove 30p formed into the lid 10 over a lip 30pp formed on the top end 30m. Other mating means such as clamps formed on the lid can also be used to secure the lid onto the container body, as well as other variations of mating threads that consist of locking the lid to the container body by turning and engaging mating parts.

For the embodiment of the bipartite lid, shown in FIG. 4A, the upper lid and the lower lid are held in spaced apart relationship by a space or gap 10c, allowing the upper lid 10a to rotate freely and independently of the lower lid 10b while the lower lid 10b is secured to the container. It should be noted that in the Figures, the size of the gap 10c is for illustration only, to show that the lids are separate, and in other embodiments, the gap 10c also encompasses immediately adjacent lower and upper lids. The lower lid secures the lid 10 to the container body 30, while the upper lid 10a is rotatably coupled to the lower lid 10b. The inventors note that in the case of a single lid, shown in FIGS. 8A-B, the entire lid is slidably rotated about the top end 30m, by the lip 30pp slideably engaging the mating groove 30p.

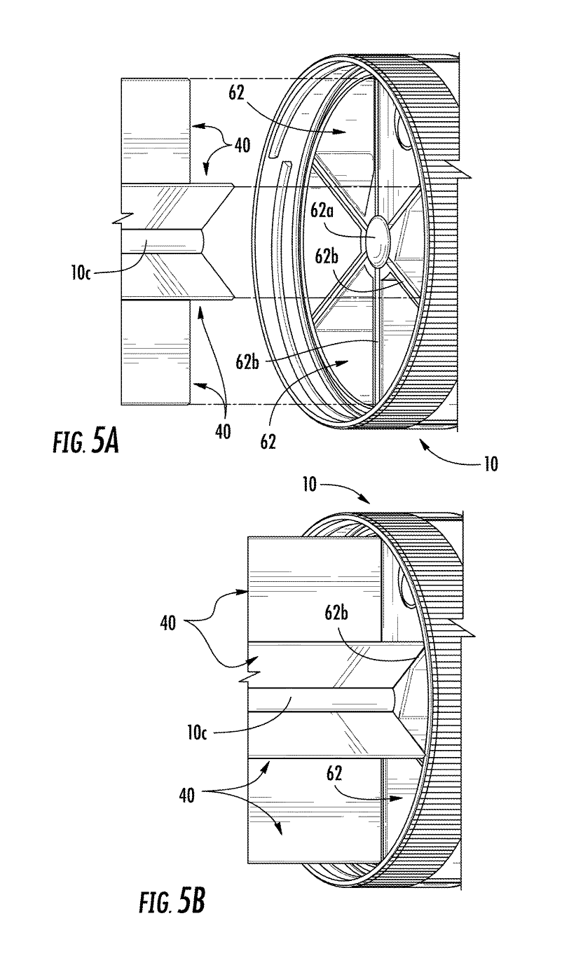

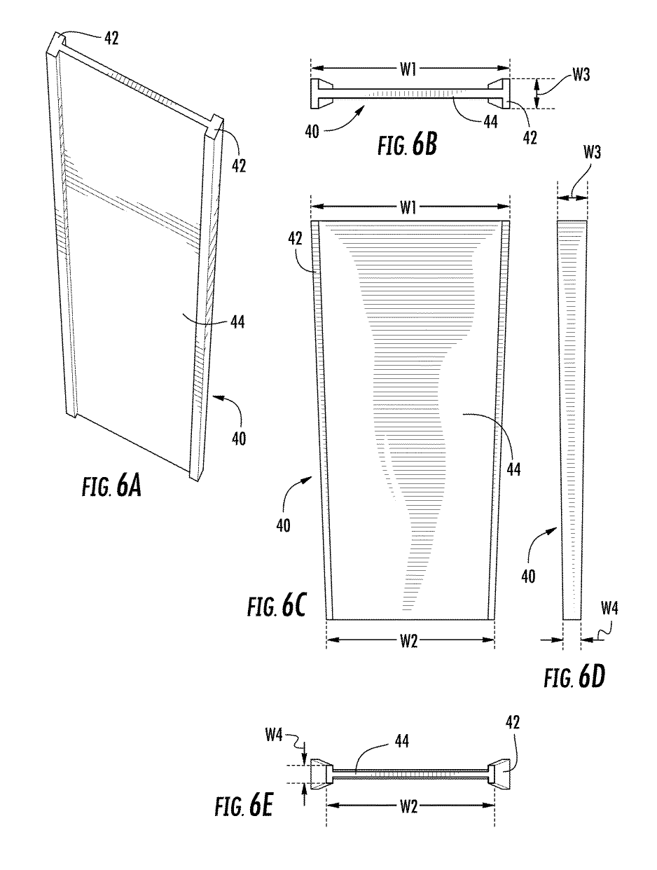

Turning now to FIGS. 4A-B, and FIGS. 5A-B, the underside of the lid 10 is formed with a plurality of hollow spaces 62 defined by a spoke-like array of lid channels 62b radiating outwards from a circular, raised center post seal 62a towards and terminating at a perimeter channel 64 of the underside of the lid 10. Each hollow space 62 thus approximates an annular segment or a triangle. For the bipartite lid, the upper lid 10a is formed with the spout and/or port, and an underside of the upper lid 10a is formed with a same spoke-like array of lid channels 62b radiating outwards from the circular, raise center post seal 62a towards and terminating at the perimeter channel 64.

Each lid channel 62b is comprised of a pair of raised, parallel walls in spaced apart relationship, the space between the parallel walls sized and shaped to receive the top of the wall 40. The perimeter channel 64 is sized and shaped to receive the uppermost edge of the top end 30m of the container body 30. When the lid 10 engages the top end 30m of the container body 30, the top of the walls 40 mate with the lid channels 62b, sealing any contents stored inside the chambers 30a (FIG. 5B). A guide 10g disposed as shallow trough formed along an outermost edge of the lid 10 marks the position of each lid channel 62b (FIG. 3), to aid positioning the walls 40 into the lid channels 62b, and to provide a secondary, visual assurance that the walls 40 engage the lid channels 62b prior to dispensing the contents stored in the container body 30.

The improved container-dispenser 100 is further provided with a funnel 50, as shown in FIGS. 1A-E. It should be noted that the only time the funnel 50 is used is to fill the chambers 30a or the interior space 30aa. When the improved container-dispenser 100 is not in use, the funnel 50 is conveniently stored inside the interior space 30aa of the container body 30, with the walls 40 tucked inside the interior space 30aa about a perimeter of the funnel 50 (FIG. 1B).

The funnel 50 is uniquely sized and shaped to mate with the top end 30m of the container body 30, regardless of the number of chambers 30a, and can securely mate with the non-partitioned interior space 30aa of the container body by pressure fitting the funnel neck 50b into the container body 30 so as to span a distance between the center post 30c and the interior wall 30h. The funnel 50 features a wide mouth 50c, typically circular, with sloping inner walls tapering down into a neck 50b approximating an annular sector, with a through-passage from mouth to neck. The neck 50b is an approximate same shape as a single chamber 30a created by inserting two walls 40 immediately adjacent to one another. The inventors note that the unique size and shape of the neck 50b allows the funnel 50 to securely sit inside the top end of the container body, while allowing maximum flow of powder of other materials to quickly and easily fill the chambers 30a or interior space 30aa, as the case may be, and regardless of the configuration of chambers 30a. Unlike the prior art funnels that feature wide, round mouths and long narrow cylindrical necks, the particular size and shape of the inventors' funnel 50, mimicking the shape of the chambers, stabilizes the funnel when used, allowing for rapid and spill-free filling of the chambers.

To use the improved container-dispenser 100, a user removes the lid 10, and inserts a desired number of walls 40 into the container body 30 so as to create up to six total chambers 30a. The user then places the neck 50b of the funnel 50 into the top end 30m of the container body 30, inserting the neck 50b of the funnel 50 into a selected chamber 30a. Dietary supplements are poured into the mouth 50c and down into the chamber 30a via the neck 50b. The funnel 50 is then moved to a next empty chamber 30a to be filled. When all the chambers 30a are filled, the funnel 50 is removed. The lid 10 is then secured onto the container body 30, by mating the lid to the top end of the container body. Upon mating the lid to the container body, the user rotates the lid until the wall tops 40b mate with the lid channels 62. In a preferred embodiment, the user aligns a series of guide marks 10g on the lid, each guide 10g corresponding to a position of each lid channel 62b, with marks along the container body corresponding with the walls engaged in the wall notches, or alternatively by simply visualizing the wall positions through the container body. The user is further aided in sealing contents stored in each chamber by a “clicking” sound caused when the lid is rotated and the wall tops 40b engage the lid channels via a pressure fit as the wall tops 40b are forced over and into each lid channel 62b. In turn, the lid channels 62b prevent the lid 10 from accidentally turning and thus potentially spilling or cross contaminating contents from one chamber into another chamber or out of a port or spout.

To access the stored supplements, the user first determines whether the spout or the port will be used to dispense the supplements stored in the chamber 30a. The spout is typically used for dispensing powders, and the port is typically used for dispensing pills, granola, small crackers, etc. Locating the relevant spout or port, the user then grasps the upper lid 10a, in the embodiment with the bipartite lids, or grasps any part of the lid 10 in the embodiment comprised of the single lid, and rotates the relevant dispensing opening (spout or port) until a desired chamber is positioned directly below the relevant spout or port, as chosen by the user. As the lid is turned, each wall top 40b slides out of its respective lid channel 62b and is repositioned into an adjacent lid channel 62b as the lid is rotated. Access to any specific chamber is achieved by rotating the spout 10d or port 20, as desired, directly over the desired chamber. To dispense apportioned or pieced dietary supplements such as pills, nuts, granola, and other larger apportioned supplements, the port is positioned over the desired chamber and the port lid opened so as to provide access the chamber's contents. The lid channels 62b prevent the contents of the other chambers 30a from being dispensed. Turning to Figure XXX, the aperture 10f is shown as a through-hole leading directly to an opening in the spout 10d. The port 20 is typically oriented opposed the spout, although the location of the port 20 in relation to the spout 10d could be immediately adjacent or any other variation so long as the port location does not interfere with operation of the spout and vice versa.

The inventors have noted through personal experience that water bottles, purchased prefilled, or reusable and self-filled, are convenient containers into which powdered supplements may be dispensed, mixed, and then ingested. They have noted however that trying to pour powdered supplements into a small water bottle neck is difficult because powder is difficult to pour and control, and measuring utensils such as scoops are not designed for pouring powders into narrow openings. Hence, the invention 100 allows the user to quickly and conveniently store premeasured quantities of powder into a single chamber by using the funnel 50 to easily direct the measured powder quickly and cleanly into the chambers 30a. Dispensing the stored powder is easily achieved using the spout. To use the spout 10d, the spout is flipped up and the contents of the chamber directly below the spout can be dispensed through the spout 10d by simply tilting the container body 30. The spout in particular allows for neat and accurate dispensing of powdered dietary supplements into a small opening, such as a mouth of a water bottle.

The container body 30a is typically made of a transparent or translucent BPA-free plastic, to allow users to visually identify chamber contents. In some embodiments, the lid 10 will allow for identification of contents, or other means of discerning differences between chamber contents, such as by using numbers, days of the week, etc. on the lid itself so as to allow the user a further visual reminder of contents, dosage, order of use, and other pertinent information. The container height, in a typical embodiment, is approximately 6-8 inches, but the inventors note that many different sizes are possible. A diameter of the container body, in a typical embodiment, is approximately 4 inches measured at the bottom end 30k of the container body, but again, a variety of diameters are suitable according to desired use by the user.

It is to be understood that the above-described arrangements are only illustrative of the application of the principles of the present invention. Numerous modifications and alternative arrangements may be devised by those skilled in the art without departing from the scope of the present invention. For instance, the inventors note that the bipartite lid described above can be made in a variety of ways to allow the lower lid to secure the entire lid structure onto the container body and yet allow the upper lid to rotate. For instance, a rim or flange may be formed inside the perimeter of both lower and upper lids, with the rim or flange of one lid resting atop the rim or flange of the other. This sort of arrangement is already present on a number of portable coffee mug lids with rotating open/close ports to allow the user to drink the beverage or close the drinking port by rotating a lid over the opening. Many other bipartite lids are known in the art, and the inventors believe that many existing bipartite lid mechanisms can be used with their invention, so long as the lids incorporate the unique lid channel design as described above.

What is claimed is:

1. An apparatus (100) for storing and dispensing a quantity of dietary supplements, the apparatus comprising:
a container body (30) having an opening at a top end (30m), an opposed bottom end (30k) having a base (30i), and an interior wall (30h) defining an interior space (30aa);
a center post (30c) affixed to, and rising up from, the bottom end (30k) into the interior space (30aa) to the top end (30m);
a wall (40); and
means for affixing the wall (40) to the center post (30c) and the interior wall (30h);
wherein the interior space (30aa) is accessed through an opening at the top end (30m); and
wherein the wall (40) is affixed to the center post (30c), the interior wall (30h) and the base (30i) inside the interior space (30aa).

2. The apparatus of claim 1, wherein means for affixing the wall (40) to the center post (30c) and to the interior wall (30h) further comprise:
a post notch (30d) formed into the center post (30c); and
a wall notch (30dd) formed into the interior wall (30h), the wall notch formed in parallel to the post notch (30d); and
wherein the base (30i) is further comprised of a groove (30f) formed into the base of the container body;
wherein the wall (40) is removably affixed to the center post (30c), the interior wall (30h), and to the groove (30f).

3. The apparatus of claim 2, the wall further comprising:
a wall bottom (40a);
an opposed wall top (40b);
a web (44) having a length defined by the wall bottom (40a) and the opposed wall top (40b) and a width defined by a first side and a second side; and
a pair of flanges (42) formed perpendicular to the wall bottom and opposed wall top, the pair of flanges (42) positioned along the length of the first side and the second side of the web (44);
wherein the post notch (30d) and the wall notch (30dd) are adapted to receive the pair of flanges (42), and wherein the groove (30f) is adapted to receive the wall bottom (40b).

4. The apparatus of claim 1, further comprising:
a lid (10) having a spout (10d) formed on a topside of the lid and at least two lid channels (62b) in spaced apart relationship formed on an underside of the lid, the at least two lid channels (62b) defining a hollow space (62); and
means for affixing the lid (10) to the top end (30m) of the container body (30).

5. The lid of claim 4, further comprising:
an upper lid (10a), and
a lower lid (10b);
wherein the upper lid (10a) is coupled to the lower lid (10b) so as to allow the upper lid to rotate independently of the lower lid (10a).

6. The lid of claim 4, wherein means for affixing the lid (10) to the top end (30m) is a mating groove (30p) formed along the underside of the lid engaging a lip (30pp) formed into the container body (30) at a top end (30m).

7. The lid of claim 4, wherein means for affixing the lid (10) to the top end (30m) are mating threads (10bb 30gg) formed along both an underside of the lid and the top end (30m).

8. The apparatus of claim 4, wherein at least one of the container body and the lid is made of a BPA-free plastic.

9. The apparatus of claim 4, wherein the lid (10) is further comprised of a port (20) and a port lid (20a) hingeably affixed to the lid.

10. The apparatus of claim 1, further comprises a second wall (40) affixed to the center post (30c) and the interior wall (30h) and adjacent to the wall (40), the walls (40) defining a chamber (30a) of a predetermined volume.

11. A funnel (50) mateable with a container body (30) having an interior space (30aa) pierced by a center post (30c) and defined by a curved interior wall (30h), the container body (30) further having an opening at a top end (30m), the funnel(50)comprising:
a mouth (50c);
a neck (50b) affixed to a terminal end of the mouth (50); and
a through-passage extending between the mouth and the neck;
wherein the neck (50b) approximates an annular sector having a first curved wall of a predetermined length that is a shorter length than a length of a second curved wall.

12. The funnel (50) of claim 11 wherein the neck (50) is sized and shaped to mate with the top end (30m) of the container body (30) between the center post (30c) and the curved interior wall (30h).

13. A lid (10) for a container body (30) having a storage chamber (30a) and at least one wall (40) having a wall top (40b), the lid (10) comprising:
an underside and a top side;
an interior perimeter channel (64) along the outermost perimeter of the underside; and
means for coupling the lid (10) to the container body (30);
wherein the underside is further comprised of a spoke-like array of lid channels (62b) radiating outwards from a raised center post seal (62a) to the perimeter channel 64; and
wherein at least one of the lid channels (62) is mateable with the wall top (40b)

14. The lid (10) of claim 13, wherein the top side is further comprised of at least one of a spout (10d) and a port (20).
